(19) United States
(12) Patent Application Publication
(10) Pub. No.: US 2026/0229775 A1
(43) Pub. Date: Aug. 6, 2026

(54) METHOD AND APPARATUS FOR TERMINATING A TIME DIVISION DUPLEX PHASED ARRAY ANTENNA

(71) Applicant: Qorvo US, Inc., Greensboro, NC (US)

(72) Inventors: Wade C. Allen, Newton, MA (US); Curtis Crockett, San Diego, CA (US); Tyler Eaves, San Diego, CA (US); Tissana T. Kijsanayotin, La Jolla, CA (US); Ian Gresham, Camden, ME (US); Ryan Jennings, Broomfield (CA)

(21) Appl. No.: 19/435,875

(22) Filed: Dec. 30, 2025

Related U.S. Application Data
(60) Provisional application No. 63/750,935, filed on Jan. 29, 2025.

(51) Int. Cl. H01Q 3/30; H01Q 1/24; H01Q 1/48; H01Q 9/04

(52) U.S. Cl. CPC H01Q 3/30; H01Q 1/241; H01Q 1/48; H01Q 9/0407

(57) ABSTRACT

A beamforming integrated circuit includes switchable transceivers, each including a switchable transmit circuit for a first polarization of an antenna, including a transmit path configured to be selectively enabled, and a switchable transmit impedance matching network connected to the transmit path. Each of the switchable transceivers also includes a switchable receive circuit for a second polarization of the antenna, including a receive path configured to be selectively enabled, and a switchable receive impedance matching network connected to the receive path. In the transmit state, the transmit path is enabled, the receive path is disabled, the switchable transmit impedance matching network is disabled, and the switchable receive impedance matching network is enabled. In in the receive state the transmit path is disabled, the receive path is enabled, the switchable transmit impedance matching network is enabled, and the switchable receive impedance matching network is disabled.

### CROSS-REFERNCE TO RELATED APPLICATIONS

This application claims the priority benefit of U.S. Provisional Patent Application No. 63/750,935, filed January 29, 2025, which is hereby expressly incorporated by reference in its entirety as though fully set forth herein

### TECHNICAL FIELD

The subject matter described herein relates to systems, devices, and methods for terminating off-state circuits in a bidirectional antenna. This beamformer off-state termination circuit has particular but not exclusive utility for beam steering of phased-array antennas.

### BACKGROUND

Low Earth orbit satellite communications (LEO SATCOM) ground terminals often require a low-cost solution and hence may use an actively steered time division duplex (TDD) phased array beamforming system where a both transmit (Tx) and receive (Rx) modes are implemented on a single phased array antenna. The beamforming integrated circuit (BFIC) for these TDD LEO systems may combine both Tx and Rx signal chains on the same die to realize a transmit/receive (TRX) BFIC. To further minimize overall system cost and optimize Rx gain to noise temperature (G/T) performance, no transmit/receive (Tx/Rx or T/R) switch is used at the antenna port like those typically found in radar or 5G TDD BFICs. Inclusion of the T/R switch will typically degrade the Rx noise figure by 1-2 dB depending on the band of operation which directly leads to G/T performance degradation. Instead, the Tx and Rx paths are separated via connection to opposite polarizations (e.g., vertical and horizontal pols) of the patch antenna. The correct polarization is then realized using other design methods such as a radome or sophisticated patch antenna array techniques.

A primary technical issue with this arrangement is the loading effect on the active path from the unknown termination impedance on the inactive path, due to finite cross-pol isolation and the absence of a front-end switch on the BFIC. This loading effect has been shown to degrade antenna performance, even for typical patch antennas with cross-pol isolation of 15 dB or better. This technical issue may be further exacerbated by each customer’s unique antenna design and difficulty predicting their loading effects.

An undefined impedance on the opposite pol could also lead to other deleterious effects, such as voltage stress at sensitive LNA inputs, unwanted leakage currents due to disabled devices turning on, or other coupling or feedback effects that could distort the active path’s performance. These effects are further aggravated over phased array scan angle, and may be difficult to predict over the range of possible angles.

Accordingly, a need exists for improved BFICs that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a beamformer off-state termination circuit that provides adequate termination impedance in the off-state for each respective element path in a TDD phased array system where the Tx and Rx path share cross-polarizations of the same patch antenna. Adequate control of off-state impedance may prevent the disabled path from adversely degrading the performance of the active element path, without compromising the primary performance of the BFIC. Failure to provide a well-defined and proper ‘off-state’ impedance to the inactive pol in the TDD system may require the customer to pay close attention to the loading effects of the BFIC in their phased array antenna design. Ensuring adequate off-state impedance control can remove this technical risk from customer’s phased array antenna design and lead to a robust system solution.

The beamformer off-state termination circuit disclosed herein has particular, but not exclusive, utility for BFICs used in phased array antennas. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a beamforming integrated circuit which includes a plurality of switchable transceivers, where each of the switchable transceivers may include: a switchable transmit circuit operatively connectable to a first polarization of an antenna, where the switchable transmit circuit may include: a transmit path configured to be selectively enabled; and a switchable transmit impedance matching network operatively connected to the transmit path. The circuit also includes a switchable receive circuit operatively connectable to a second polarization of the antenna, where the switchable receive circuit may include: a receive path configured to be selectively enabled; and a switchable receive impedance matching network operatively connected to the receive path. The switchable transceiver is switchable between a transmit state and a receive state. In the transmit state, the transmit path is enabled, the receive path is disabled, the switchable transmit impedance matching network is disabled, and the switchable receive impedance matching network is enabled. In the receive state, the transmit path is disabled, the receive path is enabled, the switchable transmit impedance matching network is enabled, and the switchable receive impedance matching network is disabled. Other embodiments of this aspect include corresponding computer systems, apparatus, and computer programs recorded on one or more computer storage devices, each configured to perform the actions of the methods.

Implementations may include one or more of the following features. In some embodiments, the switchable receive circuit further may include: a receive line configured to receive radio frequency signals and operatively connectable to a first polarization of an antenna, a low-noise amplifier operatively connected to the receive line, a receive enabler operatively connected to the low-noise amplifier and configured to enable the low-noise amplifier, where the switchable transmit circuit further may include: a transmit line configured to transmit radio frequency signals and operatively connectable to a second polarization of the antenna, a power amplifier operatively connected to the transmit line, and a transmit enabler operatively connected to the power amplifier and configured to enable the power amplifier. In some embodiments, the beamforming integrated circuit may include: a first switch configured to connect the switchable receive impedance matching network to a ground when the transmit enabler is energized, such that an impedance of the receive circuit is controlled to a first desired impedance value; and a second switch configured to connect the switchable transmit impedance matching network to the ground when the receive enabler is energized, such that an impedance of the transmit circuit is controlled to a second desired impedance value. In some embodiments, the first desired impedance value or the second desired impedance value is between 12.5 ohms and 200 ohms. In some embodiments, when connected to ground, the receive impedance matching network reduces reflections, ripple, or return loss on the transmit circuit. In some embodiments, when connected to ground, the transmit impedance matching network reduces reflections, ripple, or return loss on the receive circuit. In some embodiments, the transmit impedance matching network or the receive impedance matching network may include a resistor. In some embodiments, the transmit impedance matching network or the receive impedance matching network may include at least one of a capacitor or an inductor. In some embodiments, the transmit impedance matching network or the receive impedance matching network may include a differential amplifier. In some embodiments, the transmit impedance matching network or the receive impedance matching network may include a transformer or balun. Implementations of the described techniques may include hardware, a method or process, or computer software on a computer-accessible medium.

One general aspect includes a phased array antenna including an antenna having a first polarization and a second polarization. The antenna also includes a beamforming integrated circuit, which may include a plurality of switchable transceivers, where each of the switchable transceivers may include: a switchable transmit circuit operatively connectable to the first polarization of the antenna, where the switchable transmit circuit may include: a transmit path configured to be selectively enabled; and a switchable transmit impedance matching network operatively connected to the transmit path. The antenna also includes a switchable receive circuit operatively connectable to the second polarization of the antenna, where the switchable receive circuit may include: a receive path configured to be selectively enabled; and a switchable receive impedance matching network operatively connected to the receive path. The switchable transceiver is switchable between a transmit state and a receive state. In the transmit state, the transmit path is enabled, the receive path is disabled, the switchable transmit impedance matching network is disabled, and the switchable receive impedance matching network is enabled. In the receive state, the transmit path is disabled, the receive path is enabled, the switchable transmit impedance matching network is enabled, and the switchable receive impedance matching network is disabled. Other embodiments of this aspect include corresponding computer systems, apparatus, and computer programs recorded on one or more computer storage devices, each configured to perform the actions of the methods.

Implementations may include one or more of the following features. In some embodiments, the switchable receive circuit may include: a receive line configured to receive radio frequency signals and operatively connectable to a first polarization of an antenna, a low-noise amplifier operatively connected to the receive line, a receive enabler operatively connected to the low-noise amplifier and configured to enable the low-noise amplifier, where the switchable transmit circuit may include: a transmit line configured to transmit radio frequency signals and operatively connectable to a second polarization of the antenna, a power amplifier operatively connected to the transmit line, and a transmit enabler operatively connected to the power amplifier and configured to enable the power amplifier. In some embodiments, the phased array antenna may include: a first switch configured to connect the switchable receive impedance matching network to ground when the transmit enabler is energized, such that an impedance of the receive circuit is controlled to a first desired impedance value; and a second switch configured to connect the switchable transmit impedance matching network to ground when the receive enabler is energized, such that an impedance of the transmit circuit is controlled to a second desired impedance value. In some embodiments, the first desired impedance value or the second desired impedance value is between 12.5 ohms and 200 ohms. In some embodiments, when connected to ground, the receive impedance matching network reduces reflections, ripple, or return loss on the transmit circuit. In some embodiments, when connected to ground, the transmit impedance matching network reduces reflections, ripple, or return loss on the receive circuit. In some embodiments, the transmit impedance matching network or the receive impedance matching network may include at least one of a resistor, a capacitor, or an inductor. In some embodiments, the transmit impedance matching network or the receive impedance matching network may include a differential amplifier. In some embodiments, the transmit impedance matching network or the receive impedance matching network may include a transformer or balun. Implementations of the described techniques may include hardware, a method or process, or computer software on a computer-accessible medium.

One general aspect includes a method. The method includes providing a beamforming integrated circuit, which may include: a plurality of switchable transceivers, where each of the switchable transceivers may include: a switchable transmit circuit operatively connectable to a first polarization of an antenna, where the switchable transmit circuit may include: a transmit path configured to be selectively enabled; and a switchable transmit impedance matching network operatively connected to the transmit path. The method also includes providing a switchable receive circuit operatively connectable to a second polarization of the antenna, where the switchable receive circuit may include: a receive path configured to be selectively enabled; and a switchable receive impedance matching network operatively connected to the receive path. The method also includes switching the switchable transceiver between a transmit state and a receive state. The method also includes, in the transmit state: enabling the transmit path; disabling the receive path; disabling the switchable transmit impedance matching network; and connecting the switchable receive impedance matching to ground. The method also includes, in the receive state: disabling the transmit path, enabling the receive path, connecting the switchable transmit impedance matching network to ground, and disabling the switchable receive impedance matching network. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the beamformer off-state termination circuit, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of an example phased array antenna, in accordance with at least one embodiment of the present disclosure.

FIG. 2 is a schematic, diagrammatic representation, in block diagram form, of at least a portion of an example phased array antenna, in accordance with at least one embodiment of the present disclosure.

FIG. 3 is a schematic, diagrammatic representation of a patch antenna, in accordance with at least one embodiment of the present disclosure.

FIG. 4 is a schematic, diagrammatic representation of an impedance matching process, in accordance with at least one embodiment of the present disclosure.

FIG. 5 is a graph showing Rx channel radiative efficiency in dB as a function of frequency for various Tx termination impedance values at worst-case phase, in accordance with at least one embodiment of the present disclosure.

FIG. 6 is a schematic, diagrammatic representation of at least a portion of a phased array antenna including a beamformer off-state termination circuit, in accordance with at least one embodiment of the present disclosure.

FIG. 7 is a schematic, diagrammatic representation of at least a portion of a phased array antenna including a beamformer off-state termination circuit, in accordance with at least one embodiment of the present disclosure.

FIG. 8 is a schematic, diagrammatic representation of an example beamformer off-state termination circuit, in accordance with at least one embodiment of the present disclosure.

FIG. 9 is a schematic, diagrammatic representation of an example beamformer off-state termination circuit, in accordance with at least one embodiment of the present disclosure.

FIG. 10 is a graph of off-state output return loss (ORL) for the Rx active mode, in accordance with at least one embodiment of the present disclosure.

FIG. 11 is a graph of off-state input return loss (IRL) for the Tx active mode, in accordance with at least one embodiment of the present disclosure.

FIG. 12 shows a flow diagram of an example beamformer off-state termination method according to at least one embodiment of the present disclosure.

FIG. 13 is a schematic diagram of a processor circuit, in accordance with at least one embodiment of the present disclosure.

### DETAILED DESCRIPTION

In accordance with at least one embodiment of the present disclosure, a beamformer off-state termination circuit is included which provides a matched termination impedance in the off-state for each respective element path in a TDD phased array system where the Tx and Rx path share cross-polarizations of the same patch antenna. Adequate control of the off-state impedance may prevent the disabled path from adversely degrading the performance of the active element path on the opposite polarization due to unwanted reflections in an actively steered phased array antenna design

This solution also facilitates a robust and flexible phased array system implementation, without compromising the primary performance of the BFIC. Generally speaking, failure to provide a well-defined and proper ‘off-state’ impedance to the inactive pol in the TDD system means that the customer may need to pay close attention to the loading effects of the BFIC in their phased array antenna design. Unfortunately, these loading effects are difficult to model and predict accurately, which can lead to suboptimal designs. Thus, ensuring adequate off-state impedance control can minimize this technical risk from customer’s phased array antenna design, and thus lead to a robust phased array system solution.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

The present disclosure aids substantially in beamforming for phased array antennas, by improving the impedance of the unused polarization. Implemented on a beamforming integrated circuit (BFIC) in electrical communication with one or more patch antennas, the beamformer off-state termination circuit disclosed herein provides practical reductions in return loss for the in-use polarization. This improved circuit termination transforms an uncertain off-state load into a matched off-state load, without the normally routine need to isolate transmit and receive pathways with a T/R switch. This unconventional approach improves the functioning of the BFIC, patch antenna, and phased array by removing sources of unwanted ripple and potential voltage stress at sensitive low-noise amplifier inputs, unwanted leakage currents due to disabled devices turning on, or other coupling or feedback effects that could distort the active paths performance.

These descriptions are provided for exemplary purposes only, and should not be considered to limit the scope of the beamformer off-state termination circuit. Certain features may be added, removed, or modified without departing from the spirit of the claimed subject matter.

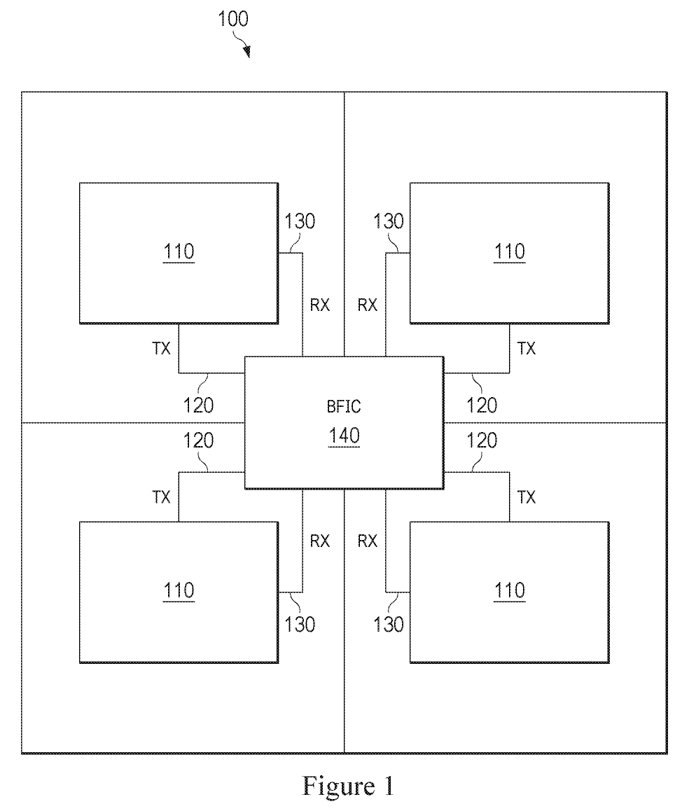

FIG. 1 is a schematic, diagrammatic representation, in block diagram form, of an example phased array antenna 100, in accordance with at least one embodiment of the present disclosure. In the example shown in FIG. 1, a representative 2 x 2 phased array antenna 100 is architected for TDD operation, where the Tx and Rx channels are connected to opposite pols of the antenna. This may for example represent a SATCOM LEO ground terminal configured to operate in half-duplex mode. The phased array antenna 100 includes four patch antennas 110, each driven by a Tx line 120 and an RX line 130 connected to opposite polarizations (e.g., vertical and horizontal polarizations, or otherwise). The Tx lines 120 and Rx lines 130 are connected to a beamforming integrated circuit (BFIC) 140.

Block diagrams are provided herein for exemplary purposes; a person of ordinary skill in the art will recognize myriad variations that nonetheless fall within the scope of the present disclosure. Block diagrams may show a particular arrangement of components, modules, services, steps, processes, or layers, resulting in a particular flow of data, energy, or signal. It is understood that some embodiments of the systems disclosed herein may include additional components, that some components shown may be absent from some embodiments, and that the arrangement of components may be different than shown, resulting in different flows while still performing the methods described herein.

Before continuing, it should be noted that the examples described above are provided for purposes of illustration, and are not intended to be limiting. Other devices and/or device configurations may be utilized to carry out the operations described herein.

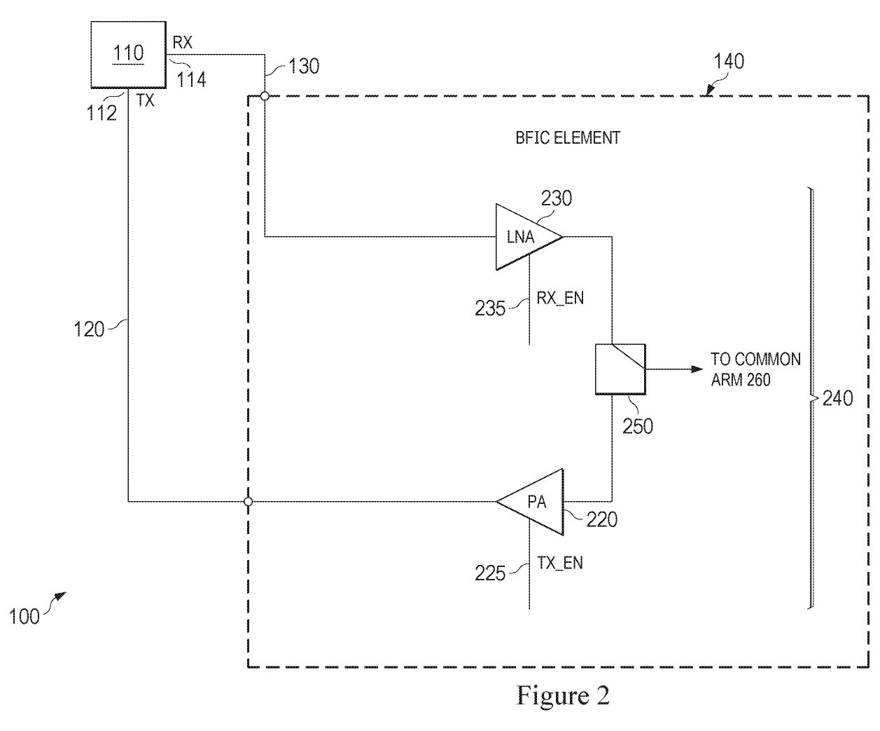

FIG. 2 is a schematic, diagrammatic representation, in block diagram form, of at least a portion of an example phased array antenna 100, in accordance with at least one embodiment of the present disclosure. Visible are one patch antenna or element antenna 110, one transmit line 120 connected to one polarization 112 of the patch antenna 110, one receive line 130 connected to the opposite polarization 114 of the patch antenna 110, and one BFIC element 240 of the BFIC 140. The Tx line 120 is connected to a power amplifier 220 which is enabled by a Tx Enabler 225, and which receives signals through a Tx/Rx switch250 from the common arm 260. Similarly, the Rx line 130 is connected to a low-noise amplifier 230 which is enabled by an Rx Enabler 235, and which sends signals through the Tx/Rx switch 250 to the common arm 260.

This pattern can be expanded to realize an n x m sized phased array for a given system, e.g., with every BFIC 140 controlling four, six, or other number of patch antennas 110.

In the half-duplex implementation, the opposite path is disabled while the active path is operating to realize more robust array performance (isolation/stability, coupling, power dissipation, etc.). For example, in Tx mode, the Rx path 130 is disabled while the Tx path 120 is operational, and vice-versa. When the inactive path is disabled, its input/output impedance becomes undefined and/or poorly controlled if care is not taken to define this ‘off-state’ impedance. This ‘off-state’ impedance will impact the loading on the cross pol of the antenna due to the finite patch antenna isolation (~15-20 dB) and could adversely degrade the active path’s performance by, for example, generating unwanted reflections, leakage currents, coupling, or feedback effects that could distort the active paths performance.

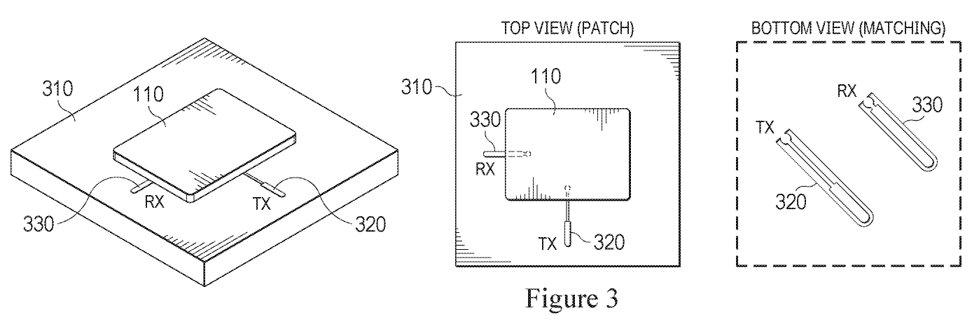

FIG. 3 is a schematic, diagrammatic representation of a patch antenna 110, in accordance with at least one embodiment of the present disclosure. The patch antenna 110 is fixedly attached to a substrate 310, and includes a Tx matching line 320 and an Rx matching line 330. The Tx matching line 320 is longer and thicker than the Rx matching line, in order to achieve the desired impedance at the BFIC Tx and Rx interface pins.

To analyze this potential negative impact of the cross-pol’s ‘off-state’ termination impedance, a model of a rectangular patch antenna for a Ku-Band TDD system was created along with the respective matching networks to transform the impedance to 50 Ohms at the BFIC interface.

Nominal patch antenna efficiency, return loss, and isolation for each port may occur for example when the opposite port is terminated with 50 ohms. For the nominal case, the performance is well behaved as expected. A 50-Ohm termination for the unused channel provides proper termination and prevents unwanted reflections in the active channel’s path. Generally speaking, an acceptable return loss for phased array applications for a Ku-Band patch antenna is below -15 dB. Nominal isolation is better than 15 dB at all frequencies in the band of interest between 10 GHz and 15 GHz. This range covers an expected Rx band from 10.75-12.75 GHz and an expected Tx band from 13.75-14.5 GHz, thus showing that a 50-Ohm impedance for the unused channel provides adequate isolation in both the Tx and Rx modes. Generally speaking, a typical cross-pol isolation for phased array applications is 15 dB.

The efficiencies of the Rx channel are above -1 dB in an expected Rx band from 10.75-12.75 GHz, and the efficiencies of the Tx channel are above -1 dB in an expected Tx band from 13.75-14.5 GHz. Both efficiency curves are well behaved with no ripple thus showing that a 50-Ohm impedance for the unused channel provides adequate efficiency in both the Tx and Rx modes.

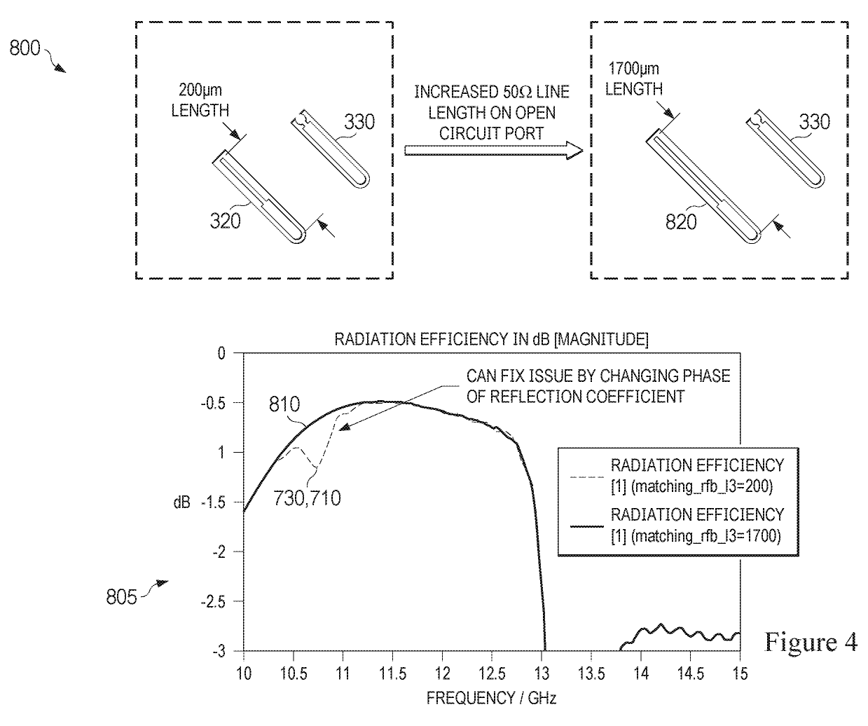

FIG. 4 is a schematic, diagrammatic representation of an impedance matching process 800, in accordance with at least one embodiment of the present disclosure. Since a 50 Ohm termination is not guaranteed on the inactive pol in the actual system, this efficiency is simulated at the Rx port with the Tx Port is load pulled to quantify the sensitivity of the active path to the disabled path’s loading. The worst case phase with worst case open circuit termination on Tx results in unwanted efficiency ripple of -0.5dB occurring in the lower portion of the Rx band at 10.75 GHz. This result demonstrates that the ‘off-state’ termination of the opposite path could adversely impact the patch antenna’s performance, at least for the extreme worst case.

In the example shown in FIG. 4, the Tx matching line 320, with a length of 200 microns, is replaced with a Tx matching line 820 that has a length of 1700 microns. As shown in a graph 800, the resulting radiative efficiency 810 does not show the ripple 730 that was observed in the radiative efficiency 710 of the off-nominal case. This shows that the unwanted ripple can be eliminated or greatly reduced by changing the phase of the reflection coefficient by increasing the 50 Ohm matching line length. However, this may not be a desirable solution approach, as it requires detailed knowledge of the BFIC ‘off-state’ impedance and careful management of the phase shift to the patch antenna. Both of these parameters may be difficult to predict across multiple customers and multiple array designs.

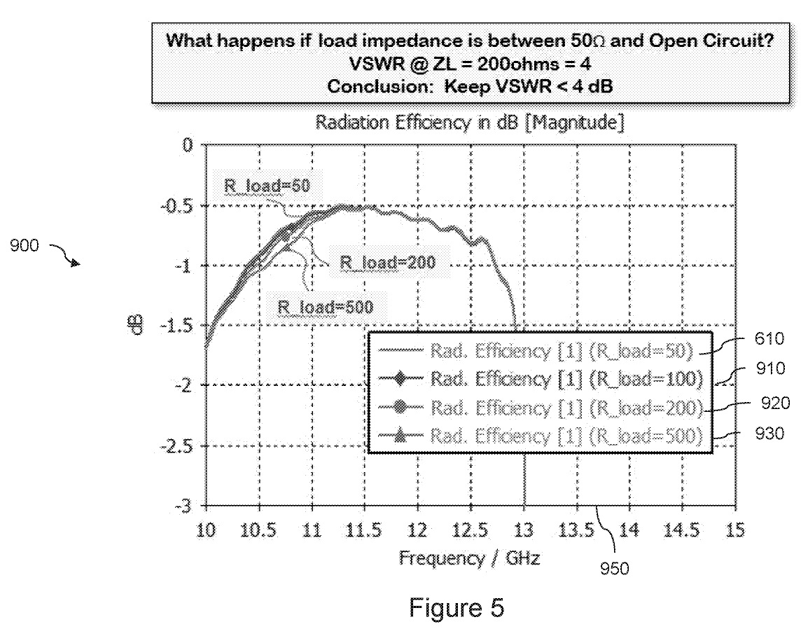

FIG. 5 is a graph 900 showing Rx channel radiative efficiency in dB as a function of frequency 950 for various Tx termination impedance values at worst-case phase, in accordance with at least one embodiment of the present disclosure. Visible are the radiative efficiency 610 at 50 Ohms, as well as radiative efficiencies 910, 920, and 930 at 100 Ohms, 200 Ohms, and 500 Ohms, respectively.

The graph 900 can be used to select an adequate off-state termination impedance that will prevent unwanted ripple in the active path’s antenna efficiency response. To quantify the adequate impedance level, the Tx termination resistance is swept at the worst-case reflection phase found above to find the maximum voltage standing wave ratio (VSWR) allowed for guaranteed minimal ripple (e.g., a ripple of less than 0.1dB) in the Rx band. The graph 900 shows that a VSWR < 4, where VSWR is calculated from the R_load ratio to the target R_load of 50 Ohms, results in minimal impact (e.g., less than 0.1 dB) on the opposite pol’s efficiency. Thus, achieving an off-state return loss of < -4.4 dB across the opposite path’s band ensures the phased array antenna performance will not be degraded with loading by the opposite path, and will make the BFIC robust to various antenna implementations across multiple customers. This antenna array analysis shows the need for the beamformer off-state termination circuit to be implemented in the BFIC.

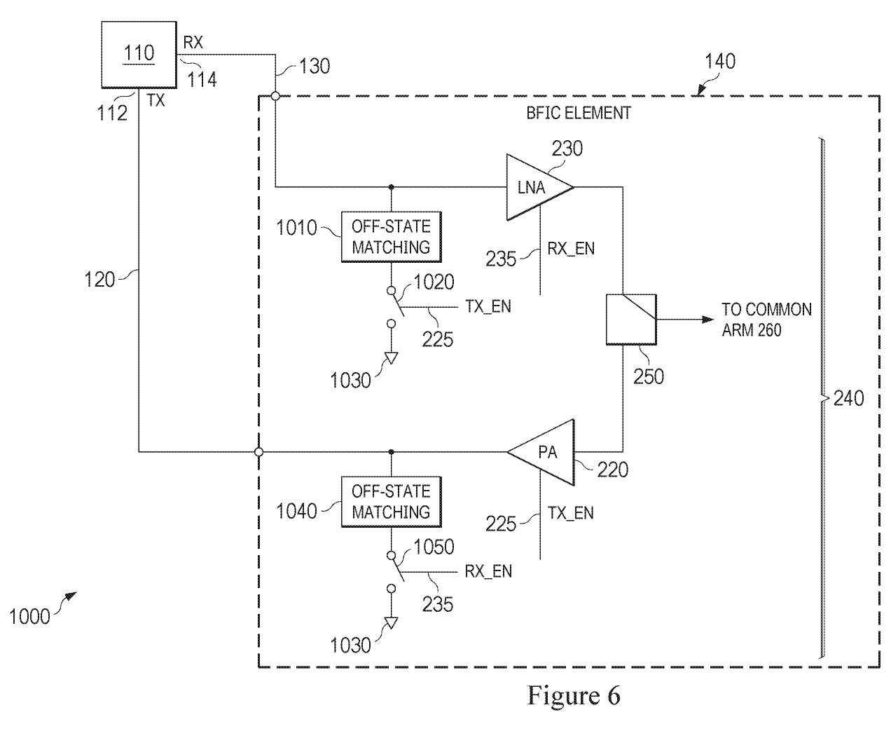

FIG. 6 is a schematic, diagrammatic representation of at least a portion of a phased array antenna 1000 including a beamformer off-state termination circuit, in accordance with at least one embodiment of the present disclosure. The phased array antenna 1000 of FIG. 6 is similar to the phased array antenna 100 of FIG. 2, with the vertically polarized Tx path 120, horizontally polarized Rx path 130, power amplifier 220, Tx Enable output 225, low-noise amplifier 230, Rx enabler 235, BFIC element 240, Tx/Rx switch 250, and common arm 260 being visible.

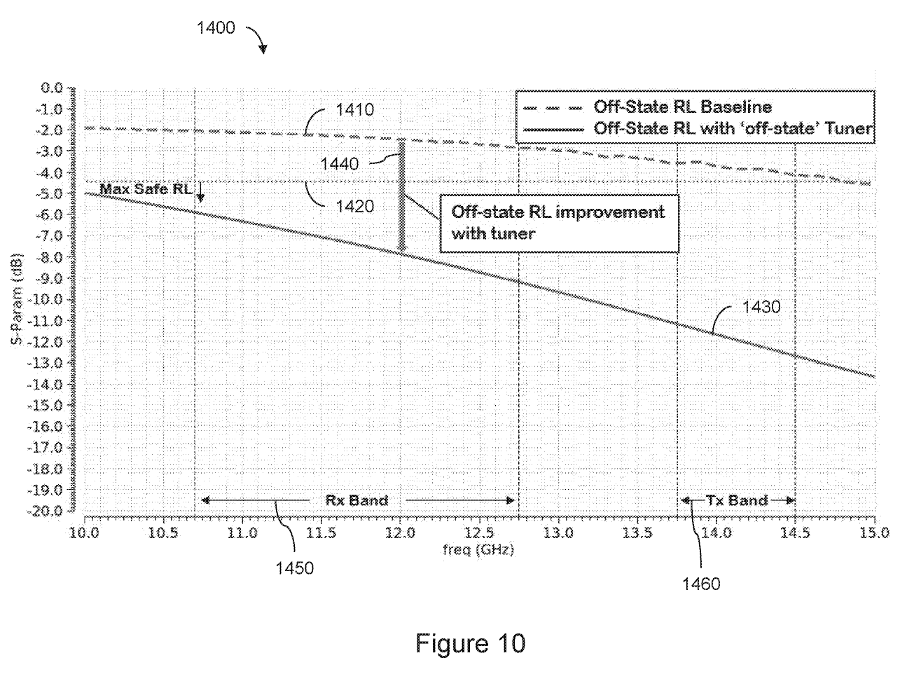

However, unlike the phased array antenna 100 of FIG. 2, the phased array antenna 1000 of FIG. 6 includes an off-state matching circuit 1010, switch 1020, and ground 1030 attached to the Rx input 130, such that when the Tx Enabler 225 is enabled, the off-state matching network 1010 is connected to the ground 1030, thus providing impedance matching for the Tx output 120 by properly terminating the Rx input when the Rx path is disabled. Similarly, the phased array antenna 1000 of FIG. 10 includes an off-state matching circuit 1040, switch 1050, and ground 1030 attached to the Tx output 120, such that when the Rx Enabler 235 is enabled, the off-state matching network 1040 is connected to the ground 1030, thus providing impedance matching for the Rx input 130 by properly terminating the Tx output when the Tx path is disabled.

In general, the off-state impedance is realized by adding matching components that are enabled when the path is disabled to ensure adequate return loss. The final implementation can be realized through various series and shunt matching components, including inductors, capacitors, and/or resistors, to realize the desired off-state impedance.

For the implementation shown in FIG. 6, the ‘off-state’ terminations are realized by switching in shunt components when the respective path is disabled.

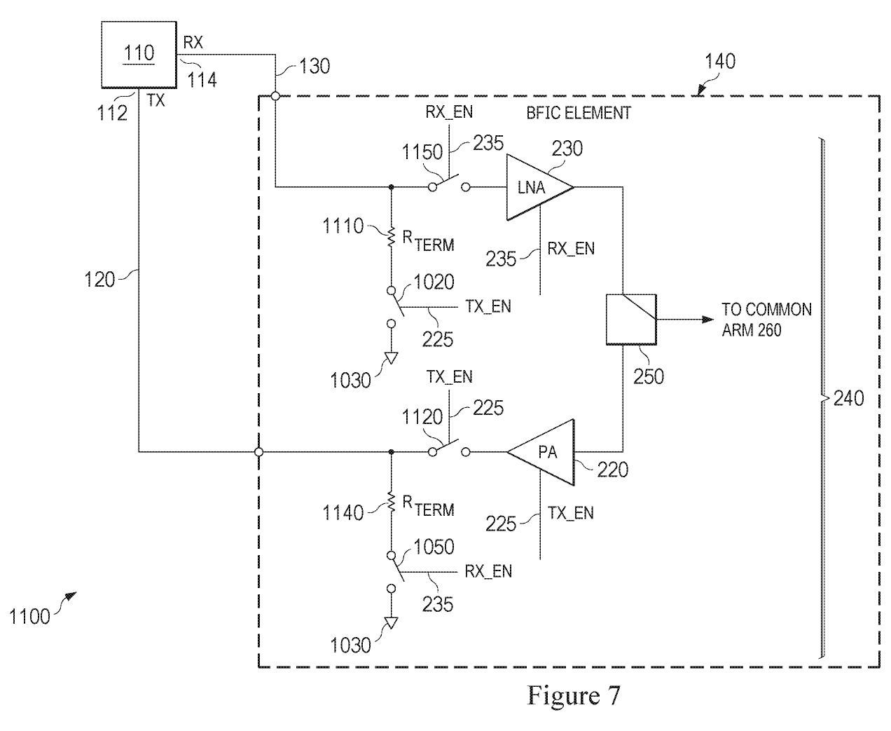

FIG. 7 is a schematic, diagrammatic representation of at least a portion of a phased array antenna 1100 including a beamformer off-state termination circuit, in accordance with at least one embodiment of the present disclosure. The phased array antenna 1100 of FIG. 7 is similar to the phased array antenna 100 of FIG. 2, with the vertically polarized Tx path 120, horizontally polarized Rx path 130, power amplifier 220, Tx Enabler 225, low-noise amplifier 230, Rx enabler 235, BFIC element 240, TX/RX switch 250, and common arm 260 being visible.

However, unlike the phased array antenna 100 of FIG. 2, the phased array antenna 1100 of FIG. 7 includes, on the transmit output 120: a series switch 1120, shunt resistor or termination resistor 1140, shunt switch 1050, and ground 1030, such that when the Rx Enable is enabled and the Tx output is disabled, the transmit line 120 to the antenna 110 is shunted to ground 1030 through the shunt resistor or termination resistor 1140.

Similarly, the phased array antenna 1100 of FIG. 7 includes, on the receive input 130: a series switch 1150, shunt resistor or termination resistor 1110, shunt switch 1020, and ground 1030, such that when the Tx Enable is enabled and the Rx Enable is disabled, the receive line 130 from the antenna 110 is shunted to ground 1030 through the shunt resistor or termination resistor 1110.

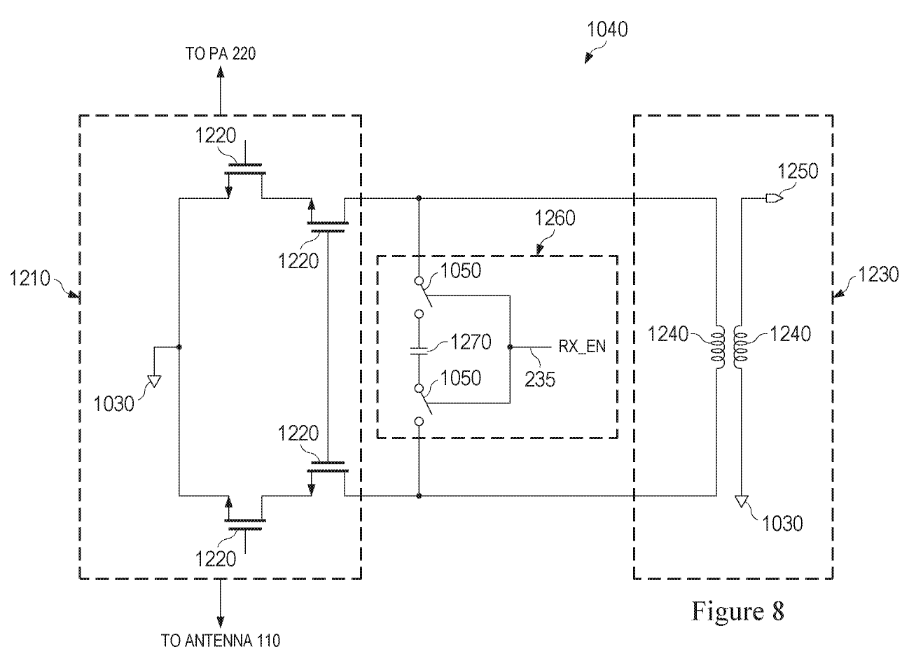

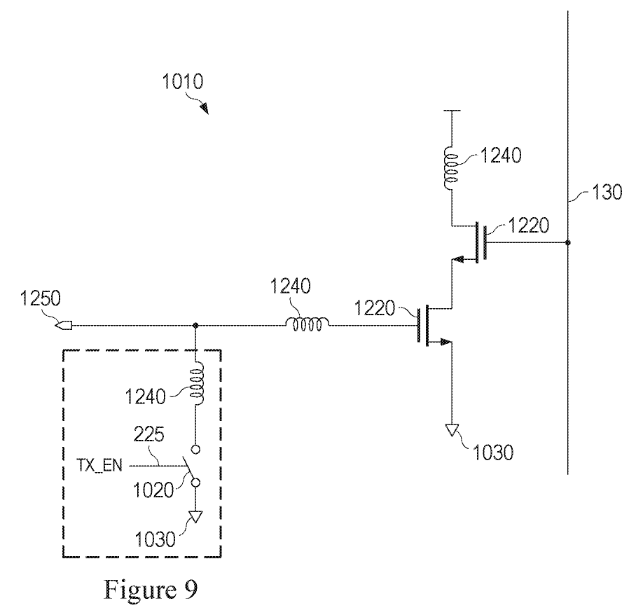

Thus, the system directly provides off-state impedance by adding a series switch between each BFIC antenna port and the LNA input and PA output along with a shunt switchable resistor of value R_{TERM}, where R_{TERM} is the optimum port impedance – typically 50 Ohms. One drawback of this approach is that the additional insertion loss introduced by the series switch can have an adverse impact on the Rx noise figure and Tx output power – similar to incorporating a T/R switch into the circuit. In some cases, this additional loss may be an acceptable trade-off if the BFIC includes high-performance switches with very low insertion loss. However, it may be preferable for the desired off-state impedance to be realized without adding additional losses that degrade the baseline performance, as shown in FIGS. 8 and 9.

FIG. 8 is a schematic, diagrammatic representation of an example beamformer off-state termination circuit 1040, in accordance with at least one embodiment of the present disclosure. The beamformer off-state termination circuit 1040 is switched in at the output of the power amplifier 220, and includes a differential amplifier 1210, a matching network 1260, and a balun 1230. The example differential amplifier 1210 includes four transistors 1220 and a ground 1030. The example matching network 1260 is parallel to the differential amplifier and includes two switches 1050 that switch in a shunt capacitor 1270 when the Rx Enabler is enabled (e.g., when the Tx output 120 is disabled). The example balun 1230 includes two inductors 1240 arranged as a transformer, plus a ground 1030 and RF output port 1250.

It is understood that the beamformer off-state termination circuit 1040 shown in FIG. 8 is exemplary only, and that myriad other components (whether capacitive, resistive, inductive, or combinations thereof) could be arranged to produce a similar effect of providing ~50-200 Ohm off-state termination to the Tx output across a range of receive frequencies.

FIG. 9 is a schematic, diagrammatic representation of an example beamformer off-state termination circuit 1010, in accordance with at least one embodiment of the present disclosure. The beamformer off-state termination circuit 1010 is switched in at the output 130 of the low-noise amplifier 230, and includes two transistors 1220 and a shunt switch 1020 that switches in shunt inductors 1240 when the Tx Enabler is enabled (e.g., when the Rx input 130 is disabled). The example beamformer off-state termination circuit 1010 also includes a ground 1030 and RF input port 1250.

It is understood that the beamformer off-state termination circuit 1010 shown in FIG. 9 is exemplary only, and that myriad other components (whether capacitive, resistive, inductive, or combinations thereof) could be arranged to produce a similar effect of providing ~50-200 Ohm off-state termination to the Rx output across a range of transmit frequencies. The termination components can be placed on either side of the input matching components represented by inductor 240.

FIG. 10 is a graph 1400 of off-state output return loss (ORL) for the Rx active mode, in accordance with at least one embodiment of the present disclosure. Curve 1410 represents the power amplifier output return loss when disabled, without the beamformer off-state termination circuit in place. This is the return loss at the termination point of the patch antenna Tx route 320 shown in FIG. 3. Curve 1410 demonstrates that output return loss in the Rx band 1450 without the tuner in place is at a level that could introduce unwanted reflection in the Rx band, e.g., it is greater than the maximum safe return loss 1420. Curve 1430 shows the improvement 1440 of adding off-state matching via the beamformer off-state termination circuit, which reduces the PA output return loss 1430 below the safe level 1420 to eliminate potential ripple in the Rx band 1450.

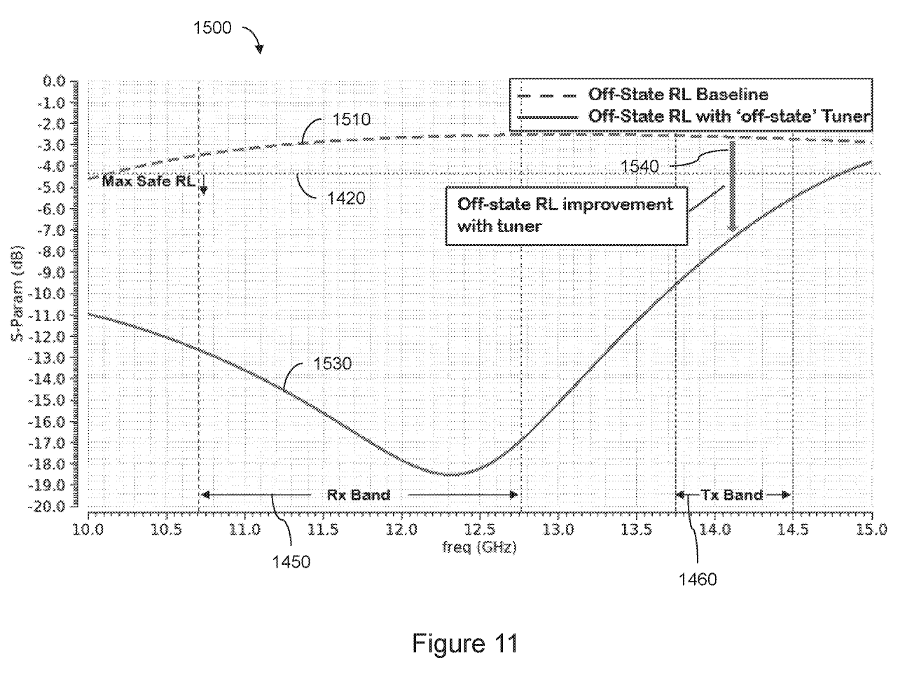

FIG. 11 is a graph 1500 of off-state input return loss (IRL) at the BFIC Rx input for the Tx active mode, in accordance with at least one embodiment of the present disclosure. Curve 1510 represents the low-noise amplifier input return loss when disabled, without the beamformer off-state termination circuit in place. This is the return loss at the termination point of the patch antenna Rx route 330 shown in FIG. 3. Curve 1510 shows that the Rx IRL in the Tx Band 1460 without the tuner in place is at a level that could introduce unwanted reflection in the Tx band while the Tx path is operational (e.g., the IRL is greater than the maximum safe return loss 1420 of -4.5 dB.

However, line 1530, with the beamformer off-state termination circuit in place, shows a significant improvement 1540 such that the return loss 1530 is smaller than the maximum safe value 1420 in the Tx band 1460. It is noted that this exemplary implementation has the additional challenge of the offset between the Tx band 1460 and the Rx band 1450. However, the same concept would apply if the Tx and Rx occupied the same frequency band.

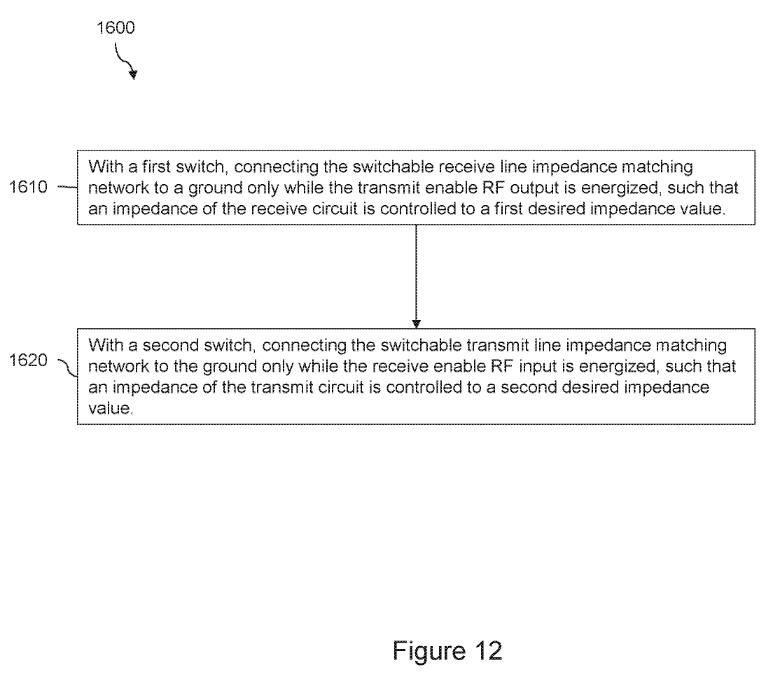

FIG. 12 shows a flow diagram of an example beamformer off-state termination method according to at least one embodiment of the present disclosure. It is understood that the steps of method 1600 may be performed in a different order than shown in FIG. 16, additional steps can be provided before, during, and after the steps, and/or some of the steps described can be replaced or eliminated in other embodiments. One or more of steps of the method 1600 can be carried by one or more devices and/or systems described herein, such as components of the system 1000, system 1100, and/or processor circuit 1750.

In step 1610, the method 1600 includes, with a first switch, connecting the switchable receive line impedance matching network to a ground only while the transmit enabler is energized, such that an impedance of the receive circuit is controlled to a first desired impedance value. Execution then proceeds to step 1620.

In step 1620, the method 1600 includes, with a second switch, connecting the switchable transmit line impedance matching network to the ground only while the receive enabler is energized, such that an impedance of the transmit circuit is controlled to a second desired impedance value.

Flow diagrams are provided herein for exemplary purposes; a person of ordinary skill in the art will recognize myriad variations that nonetheless fall within the scope of the present disclosure. The logic of flow diagrams may be shown as sequential. However, similar logic could occur in parallel, while accomplishing the same or similar functions.

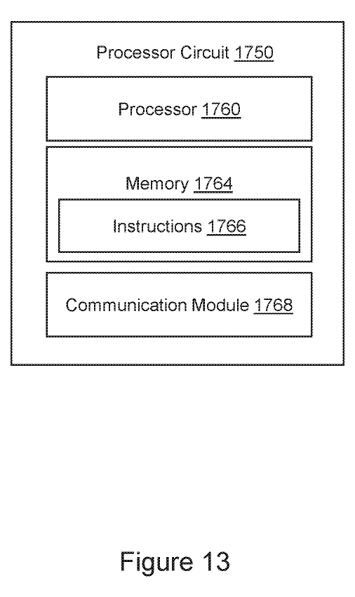

FIG. 13 is a schematic diagram of a processor circuit 1750, in accordance with at least one embodiment of the present disclosure. The processor circuit 1750 may be implemented in the system 100, 200, 1000, or 1100, or other devices or workstations (e.g., third-party workstations, network routers, etc.), or on a cloud processor or other remote processing unit, as necessary to implement the method. As shown, the processor circuit 1750 may include a processor 1760, a memory 1764, and a communication module 1768. These elements may be in direct or indirect communication with each other, for example via one or more buses.

The processor 1760 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1760 may also comprise another hardware device, a firmware device, or any combination thereof configured to perform the operations described herein. The processor 1760 may also be implemented as a combination of computing devices, e.g., a combination of a DSP and a microprocessor, a plurality of microprocessors, one or more microprocessors in conjunction with a DSP core, or any other such configuration.

The memory 1764 may include a cache memory (e.g., a cache memory of the processor 1760), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1764 includes a non-transitory computer-readable medium. The memory 1764 may store instructions 1766. The instructions 1766 may include instructions that, when executed by the processor 1760, cause the processor 1760 to perform the operations described herein. Instructions 1766 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1768 can include any electronic circuitry and/or logic circuitry to facilitate direct or indirect communication of data between the processor circuit 1750, and other processors or devices. In that regard, the communication module 1768 can be an input/output (I/O) device. In some instances, the communication module 1768 facilitates direct or indirect communication between various elements of the processor circuit 1750 and/or the system 100, 200, 1000, or 1100. The communication module 1768 may communicate within the processor circuit 1750 through numerous methods or protocols.

Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or signals to and from the antenna) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles) , 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the beamformer off-state termination circuit advantageously controls the off-state impedance of the inactive pol of a TDD phased array antenna element, thus reducing unwanted reflections, ripple, and return losses.

A number of variations are possible on the examples and embodiments described above. For example, the switchable matching networks for either or both of the Tx and Rx channels may include resistive, capacitive, or inductive elements, or combinations thereof as would occur to a person of ordinary skill in the art. The technology described herein may be implemented on a semiconductor integrated circuit chip (e.g., silicon, gallium arsenide, etc.), or may implemented in a printed circuit board (PCB), or combinations thereof.

The logical elements making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader’s understanding of the claimed subject matter, and do not create limitations, particularly as to the position, orientation, or use of the beamformer off-state termination circuit. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the beamformer off-state termination circuit as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A beamforming integrated circuit comprising:
a plurality of switchable transceivers, wherein each of the switchable transceivers comprises:
a switchable transmit circuit operatively connectable to a first polarization of an antenna, wherein the switchable transmit circuit comprises:
a transmit path configured to be selectively enabled; and
a switchable transmit impedance matching network operatively connected to the transmit path; and
a switchable receive circuit operatively connectable to a second polarization of the antenna, wherein the switchable receive circuit comprises:
a receive path configured to be selectively enabled; and
a switchable receive impedance matching network operatively connected to the receive path,
wherein the switchable transceiver is switchable between a transmit state and a receive state,
wherein in the transmit state, the transmit path is enabled, the receive path is disabled, the switchable transmit impedance matching network is disabled, and the switchable receive impedance matching network is enabled, and
wherein in the receive state, the transmit path is disabled, the receive path is enabled, the switchable transmit impedance matching network is enabled, and the switchable receive impedance matching network is disabled.

2. The beamforming integrated circuit of claim 1:
wherein the switchable receive circuit further comprises:
a receive line configured to receive radio frequency signals and operatively connectable to a first polarization of an antenna;
a low-noise amplifier operatively connected to the receive line;
a receive enabler operatively connected to the low-noise amplifier and configured to enable the low-noise amplifier; and
wherein the switchable transmit circuit further comprises:
a transmit line configured to transmit radio frequency signals and operatively connectable to a second polarization of the antenna;
a power amplifier operatively connected to the transmit line; and
a transmit enabler operatively connected to the power amplifier and configured to enable the power amplifier.

3. The beamforming integrated circuit of claim 2, further comprising:
a first switch configured to connect the switchable receive impedance matching network to a ground when the transmit enabler is energized, such that an impedance of the receive circuit is controlled to a first desired impedance value; and
a second switch configured to connect the switchable transmit impedance matching network to the ground when the receive enabler is energized, such that an impedance of the transmit circuit is controlled to a second desired impedance value.

4. The beamforming integrated circuit of claim 3, wherein the first desired impedance value or the second desired impedance value is between 12.5 Ohms and 200 Ohms.

5. The beamforming integrated circuit of claim 1, wherein when connected to ground, the receive impedance matching network reduces reflections, ripple, or return loss on the transmit circuit.

6. The beamforming integrated circuit of claim 1, wherein when connected to ground, the transmit impedance matching network reduces reflections, ripple, or return loss on the receive circuit.

7. The beamforming integrated circuit of claim 1, wherein the transmit impedance matching network or the receive impedance matching network comprises a resistor.

8. The beamforming integrated circuit of claim 1, wherein the transmit impedance matching network or the receive impedance matching network comprises at least one of a capacitor or an inductor.

9. The beamforming integrated circuit of claim 1, wherein the transmit impedance matching network or the receive impedance matching network comprises a differential amplifier.

10. The beamforming integrated circuit of claim 1, wherein the transmit impedance matching network or the receive impedance matching network comprises a transformer or balun.

11. A phased array antenna comprising:
an antenna having a first polarization and a second polarization;
a beamforming integrated circuit, comprising:
a plurality of switchable transceivers, wherein each of the switchable transceivers comprises:
a switchable transmit circuit operatively connectable to the first polarization of the antenna, wherein the switchable transmit circuit comprises:
a transmit path configured to be selectively enabled; and
a switchable transmit impedance matching network operatively connected to the transmit path; and
a switchable receive circuit operatively connectable to the second polarization of the antenna, wherein the switchable receive circuit comprises:
a receive path configured to be selectively enabled; and
a switchable receive impedance matching network operatively connected to the receive path,
wherein the switchable transceiver is switchable between a transmit state and a receive state,
wherein in the transmit state, the transmit path is enabled, the receive path is disabled, the switchable transmit impedance matching network is disabled, and the switchable receive impedance matching network is enabled, and
wherein in the receive state, the transmit path is disabled, the receive path is enabled, the switchable transmit impedance matching network is enabled, and the switchable receive impedance matching network is disabled.

12. The phased array antenna of claim 11:
wherein the switchable receive circuit comprises:
a receive line configured to receive radio frequency signals and operatively connectable to a first polarization of an antenna;
a low-noise amplifier operatively connected to the receive line;
a receive enabler operatively connected to the low-noise amplifier and configured to enable the low-noise amplifier; and
wherein the switchable transmit circuit comprises:
a transmit line configured to transmit radio frequency signals and operatively connectable to a second polarization of the antenna;
a power amplifier operatively connected to the transmit line; and
a transmit enabler operatively connected to the power amplifier and configured to enable the power amplifier.

13. The phased array antenna of claim 12, further comprising:
a first switch configured to connect the switchable receive impedance matching network to ground when the transmit enabler is energized, such that an impedance of the receive circuit is controlled to a first desired impedance value; and
a second switch configured to connect the switchable transmit impedance matching network to ground when the receive enabler is energized, such that an impedance of the transmit circuit is controlled to a second desired impedance value.

14. The phased array antenna of claim 13, wherein the first desired impedance value or the second desired impedance value is between 12.5 Ohms and 200 Ohms.

15. The phased array antenna of claim 11, wherein when connected to ground, the receive impedance matching network reduces reflections, ripple, or return loss on the transmit circuit.

16. The phased array antenna of claim 11, wherein when connected to ground, the transmit impedance matching network reduces reflections, ripple, or return loss on the receive circuit.

17. The phased array antenna of claim 11, wherein the transmit impedance matching network or the receive impedance matching network comprises at least one of a resistor, a capacitor, or an inductor.

18. The phased array antenna of claim 11, wherein the transmit impedance matching network or the receive impedance matching network comprises a differential amplifier.

19. The phased array antenna of claim 11, wherein the transmit impedance matching network or the receive impedance matching network comprises a transformer or balun.

20. A method, comprising:
providing a beamforming integrated circuit, comprising:
a plurality of switchable transceivers, wherein each of the switchable transceivers comprises:
a switchable transmit circuit operatively connectable to a first polarization of an antenna, wherein the switchable transmit circuit comprises:
a transmit path configured to be selectively enabled; and
a switchable transmit impedance matching network operatively connected to the transmit path; and
a switchable receive circuit operatively connectable to a second polarization of the antenna, wherein the switchable receive circuit comprises:
a receive path configured to be selectively enabled; and
a switchable receive impedance matching network operatively connected to the receive path,
switching the switchable transceiver between a transmit state and a receive state,
in the transmit state:
enabling the transmit path;
disabling the receive path;
disabling the switchable transmit impedance matching network; and
connecting the switchable receive impedance matching to ground, and
in the receive state:
disabling the transmit path;
enabling the receive path;
connecting the switchable transmit impedance matching network to ground; and
disabling the switchable receive impedance matching network.
